(19) United States
(12) Patent Application Publication
(10) Pub. No.: US 2016/0354707 A1
(43) Pub. Date: Dec. 8, 2016

(54) Flying Disc Animal Toy

(71) Applicant: William Stephen Polk, Virginia Beach, VA (US)

(72) Inventor: William Stephen Polk, Virginia Beach, VA (US)

(21) Appl. No.: 14/730,847

(22) Filed: Jun. 4, 2015

(51) Int. Cl. A63H 33/18; A01K 15/02

(52) U.S. Cl. CPC A63H 33/18; A01K 15/025

(57) ABSTRACT

A flying disc specifically adapted for dogs is provided. The present invention comprises a flying disc having an open central region and a plurality of grooves extending concentrically between the open central region and the rim of the disc on the top surface of the flying disc. The flying disc also preferably includes a peripheral rim having a bottom lip and an internally located tapered surface. The present invention is preferably composed of flexible material, such as natural rubber to provide flexibility to allow the dog to retrieve the flying disc. The combination of the open central region and the flexible material make the present invention easier for dogs to grasp between their teeth when catching and retrieving the disc. The grooves make the present invention easier to grip when it is resting on a flat surface.

### PRIORITY CLAIM

The present application is a continuation-in-part application of co-pending application No. 62/014,978 filed on Jun. 20, 2014.

### FIELD OF THE PNVENTION

This invention generally relates to a pet toy and in particular to a throwable toy to be used by humans in throwing games with animals, particularly with dogs.

### DESCRIPTION OF THE PRIOR ART

Throwable toys such as tennis balls or inverted platters, saucers, or discs have enjoyed great popularity as recreational items for use in throwing games and contests. Many of the throwable toys are made of a plastic material in a circular configuration with a rim portion located at its periphery, the rim portion being relatively thick in comparison to the remaining portions of the toy. In the normal inverted platter or saucer orientation, the rim curves downwardly from the toy body giving the toy a shape which approximates that of an airfoil when viewed in elevation. Such a toy has been marketed under the trademark “FRISBEE” by the Wham-o-Corp, of San Gabriel, Calif., the assignee of U.S. Pat. No. 3,724,122, issued Apr. 1973.

In throwing games, the saucer type toy is normally grasped with the thumb on the convex side of the saucer and one or more of the fingers on the concave side. Throwing is accomplished with a wrist snapping motion wherein the thrower assumes a stance approximately at right angles to the intended target and retracts his arm across his body. By uncoiling his arm and snapping his wrist, momentum and spin is imparted to the saucer to cause it to fly or glide toward the intended target. The intricacies of the disc's flight path from the thrower depends upon the thrower's skill in selecting the proper release point, the angle of the saucer relative to the ground when it is released and the rigidity of the toy. Its appeal resides in the fact that it exhibits definite aerodynamic characteristics, can be made to do in-flight maneuvers of various kinds, can be caused to glide over substantial distances, and is relatively easy to master.

Many dog trainers and breeders believe a healthy and beneficial exercise for a dog is retrieving. Not only that, but both dogs and their owners appear to greatly enjoy “playing fetch.” The most common image of this mutually pleasurable game is the dog furiously and happily racing after a thrown stick or tennis ball. Using a flying disc as described above enhances this game, since the disc can also be caught in flight.

However, unlike Man, a dog, like many other animals, lacks the opposable thumb of primates, e.g., mankind, which allows for easy grasping of materials. As a result, animals without opposable thumbs, e.g., dogs and cats, usually carry items by grasping them between their jaws. In most situations, this method of grasping is adequate. However, because of the composition and rigid configuration of conventional flying discs, when the disc is lying stationary, that and upon the ground, i.e. with its underside facing downwardly, it is difficult for the animal to pick up the disc because of the rigid outer rim, and the dog often leaves the disc without retrieving it, causing inconvenience to the thrower when he has to retrieve it himself. When the disc lands with its underside facing upwardly, the dog can readily get a grip on the periphery with his teeth and will return the disc.

While many individuals enjoy throwing flying discs for their dogs to catch, because the typical flying discs are made of hard plastic, they can damage their pets' teeth over time and the rigid disc material also makes the flying disc harder for a dog to pick up on hard or smooth surfaces. Because the flying disc is hard to pick up, dogs will revert to pawing at the disc to try and pick it up, which damages the disc and may cause damage to the dog's paw. An example of one attempt to resolve this problem is disclosed in U.S. Pat. No. 4,919,083 granted to Axelrod. In this patent, a raised top surface in the shape of a large dog bone is disclosed to provide a surface for the dog to grasp to pick up the flying disc. Other variations of a throwable animal toy are disclosed in U.S. Design Patent No. 393,110 to Mauldin, Jr., U.S. Design Patent No. 412,768 to Huettner et.al. and U.S. Pat. No. 5,360,363 granted to Levin wherein animal toys are disclosed with a Saturn like side view and having raised ball type members surrounded by a laterally extending ring.

Various types of flying disc toys are also known in the prior art that have open central regions. Some such devices comprise a throwing disc with a centres opening, whereas other such devices comprise a ring-like flying toy such as U.S. Pat. No. 4,820,230 granted to Richards. These prior art devices, however, do not fly in an arc similar to the saucer type of discs and they fail to provide a flexible flying disc toy with a grooved interior for helping aid in the holding of the disc by a dog.

The flying disc toy of the present invention provides numerous advantages over the prior art devices by providing a dog friendly version of a saucer type toy. In one form of the invention, the device is made of a pet friendly and durable natural rubber material to ensure that the jaws of the dog are not injured in a manner caused by the rigid plastic materials of the most commonly used saucer type toys. Additionally, the flying disc toy of the present invention includes multiple reinforcing ribs which provide rigidity to the flying disc while providing a raised surface for the jaws of the dog to grasp while picking up and returning the flying disc to the owner. Another advantage with a preferred form of the flying disc of the present invention is the inclusion of a tapered surface on the interior of the peripheral rim surface of the flying disc. This allows the dog to obtain a better grasp of the flying disc because the edge of the flying disc will fit better with the typical pattern of the canine's teeth.

Yet another feature of the flying disc of the present invention is the inclusion of an open center. This allows the dog to manipulate the flying disc to more easily pick it up than the rigid plastic flying discs that include a solid top surface. These and other advantages and improvements over the existing devices are described in more detail below.

### BRIEF DESCRIPTION OF FIGURES

FIG. 1 shows a top perspective view of the present invention.

FIG. 2 shows an elevated side perspective view of the present invention.

FIG. 3 shows a side view of the present invention.

FIG. 4 shows an underside view of the present invention.

FIG. 5 shows an elevated cross-sectional view of the present invention.

FIG. 6 shows an enlarged cross sectional view of a portion of the present invention.

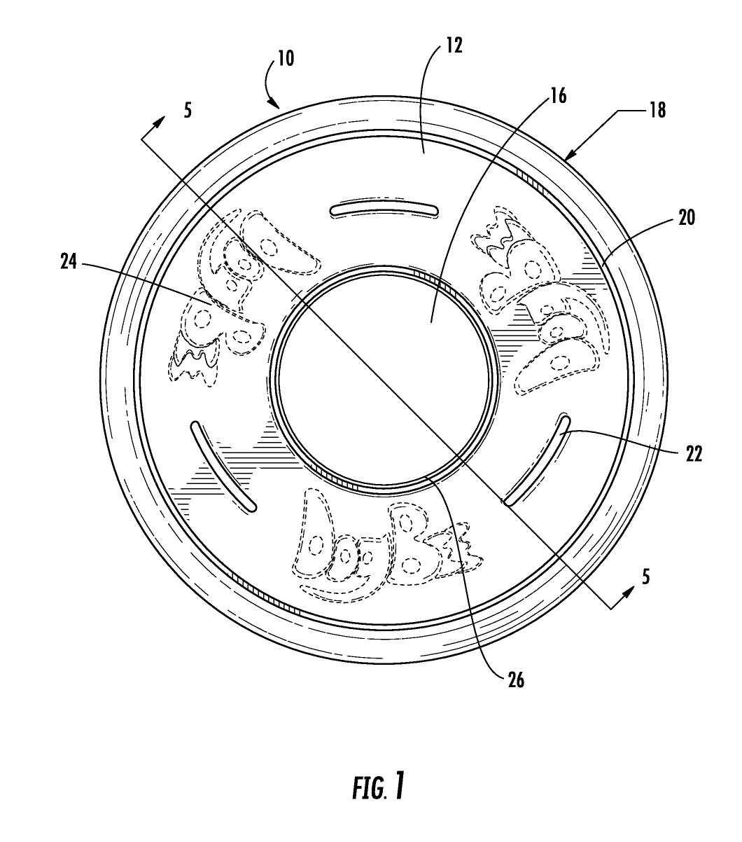

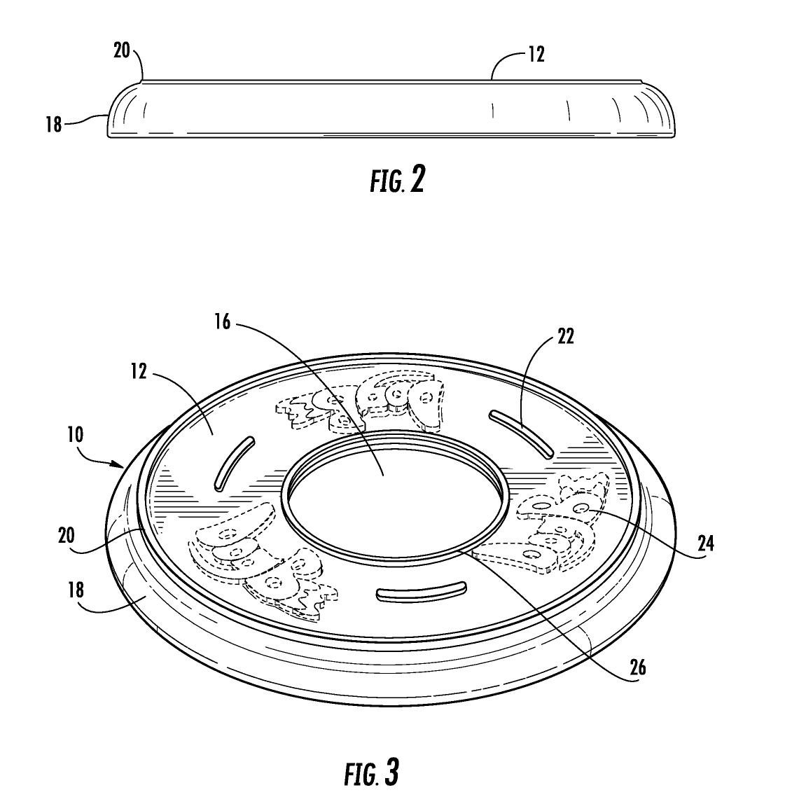

### DESCRIPTION OF INVENTION

As shown in the drawings, the present invention is directed to an improved flying disc device 10 having an overall circular shape with a top surface 12 and a bottom surface 14 and a centrally located central opening 16. The flying disc 10 also includes a peripheral rim 18 that is angled downwardly in a tapered manner from the top surface 12 to the bottom surface 14 to provide an aerodynamic surface.

The disc device is preferably formed of a non-toxic and flexible resilient material such as a natural rubber. More preferably, the disc device is made from a mixture of natural rubber and a vulcanizer and color. In one form of the invention, the disc device consists of approximately 96 percent natural rubber and a 4 percent combination consisting of a vulcanizer and coloring material. The preferred durometer of the present invention is approximately Shore A 60 or less and more preferably Shore A 40 or less. Alternately and less desirably, flying disc 10 may be formed of various flexible composites or nylons to avoid sharp edges or materials that may shred in use. The present invention is specifically adapted for use by pets because the central opening 16 and the use of a flexible material provide a device that is easier for pets to pick up and less damaging to their teeth.

As shown in elevated view and cross section, the top surface 12 of the flying disc 10 includes a peripherally located outer ridge 20 which is located adjacent to and along the entire surface of the peripheral rim 18. The outer ridge 20 extends upwardly short distance from the top surface 12 of the flying disc 10. This outer ridge 20 provides structural reinforcement to the flying disc 10 as well as well as a gripping surface for the dog to carry the flying disc. A plurality of interrupted ridges 22 are located inwardly of the outer ridge 20 on the top surface 12 to provide additional structural reinforcement and an additional gripping surface for the dog. As shown, the interrupted ridges 22 are preferably evenly spaced apart along the top surface 12 and may even be spaced apart from the each other with a script logo or raised designs 24 therebetween. As with the interrupted ridges 22, the raised designs 24 provide a gripping surface for the dog as well as contribute to the structural integrity of the flying disc 10.

The preferred form of the top surface 12 of the flying disc 10 also includes an inner ridge 26 which extends along the edge of the central opening 16. This inner ridge 26 provides additional structural integrity to the flying disc 10 while also providing a surface which assists the dog in picking up the flying disc 10 hy providing a surface which has greater structural integrity adjacent to the central opening 16. The diameter of the central opening 16 is preferably between a range of which is approximately equal to the distance along one side of the flying disc to approximately one-half of the distance along one side of the flying disc and more preferably about two-thirds of the distance along one side of the flying disc. The exact dimensions may vary because it is anticipated that multiple sizes of the present inventien will be provided to accommodate a variety of different sized dogs. Additionally, when the flying disc 10 is lying on a on a flat surface, the inner ridge 26 provides a reinforced and slightly raised surface against which the dog can paw against to help grasp the flying disc in their mouth. The inner ridge 26 also provides additional structural integrity adjacent to the central opening 16.

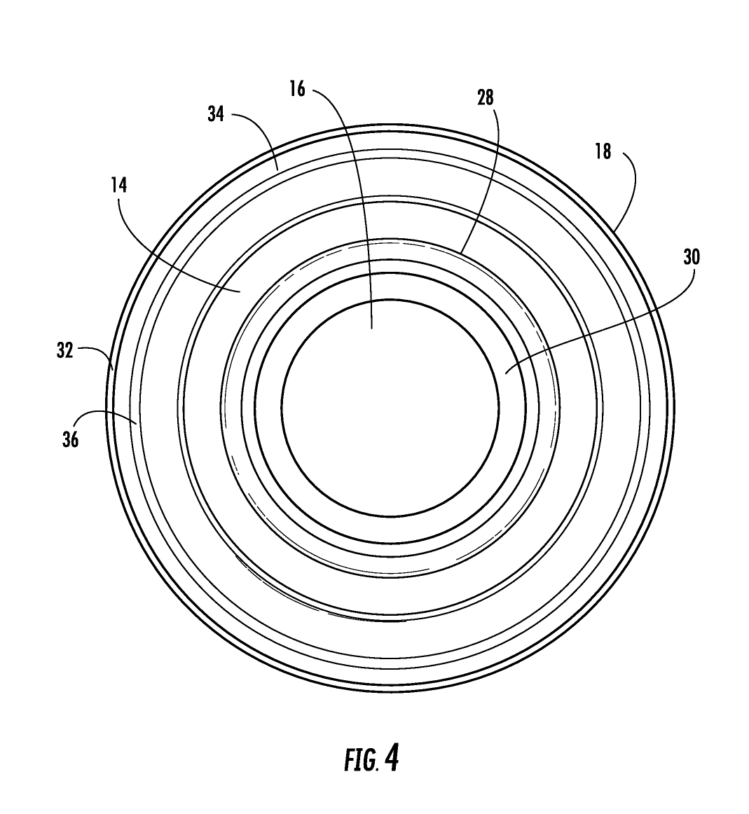

As shown in FIGS. 4-6, there are shown an underside view and a cross-sectional view of the present invention. The bottom surface 14 of the flying disc 10 includes a plurality of reinforcing ridges 28 that are aligned as concentric circles extending between the peripheral rim 18 and the central opening. These reinforcing ridges are formed to increase the structural integrity of the flying disc 10 as well as to provide a gripping surface for the dog when the dog has the flying disc in its mouth. As shown, the reinforcing ridges are preferably of generally equal height and extend downwardly from the bottom surface of the flying disc. 14 of the flying disc 10 also include a circumferential ridge 30 which extends along the bottom surface 14 adjacent to the central opening. As shown, the circumferential ridge 30 is tapered upwardly at an angle of between about 15 and 75 degrees and more preferably about 30 degrees with respect to the top and bottom surfaces of the flying disc. The circumferential ridge 30 provides increased structural integrity to the flying disc adjacent to the central opening 16 as well as providing yet another gripping surface for the dog.

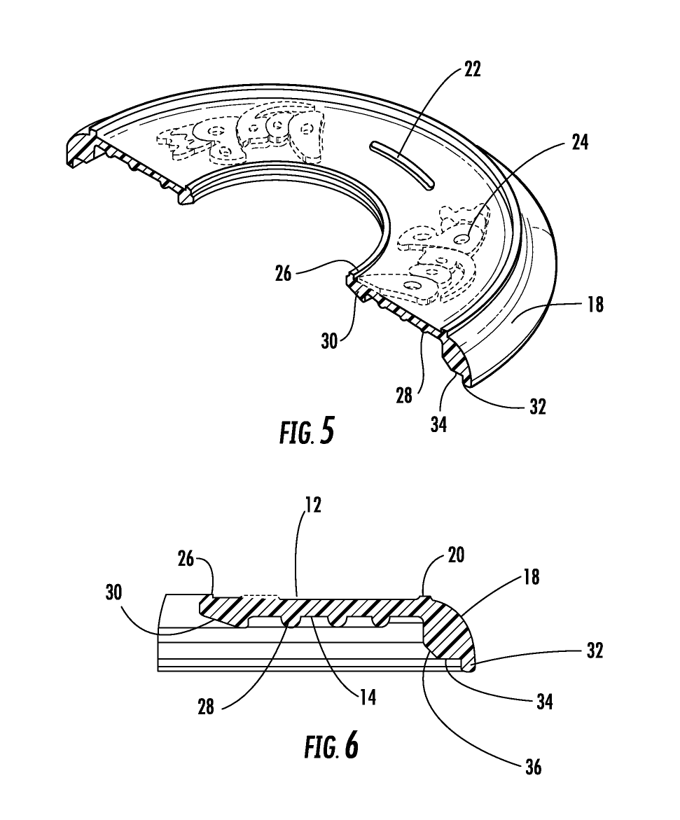

The peripheral rim 18 of the present invention includes an outer surface that is gradually tapered to provide an aerodynamic outer surface for the flying disc 10. As best shown in FIGS. 5 and 6, the inner surface of the peripheral rim 18 includes a bottom lip 32 which extends downwardly from the outer surface of the peripheral rim 18. A flat peripheral surface 34 is positioned inwardly of the bottom lip 32 bottom surface along the bottom surface of the flying disc 10. The width of the flat peripheral surface 34 is greater than the width of the bottom lip 32 to provide greater stability for the flying disc. As further shown in FIGS. 5 and 6, a tapered edge 36 is peripherally located inwardly of the flat peripheral surface 34. The tapered edge 36 preferably extends upwardly from the flat peripheral surface 34 at an angle between about 15 to 75 degrees and more particularly at an angle of about 45 degrees. Because the flying disc 10 is preferably made of a flexible material such as a natural rubber, downward pressure on the top surface 12 of the flying disc 10 will cause the bottom lip 32, flat peripheral surface 34 and tapered edge 36 to contact the ground to help maintain the structural integrity of the flying disc 10.

The foregoing descriptions of the specific embodiments of the present invention have been presented for purpose of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. An aerodynamic toy comprising:
A disc shaped member with a circular body portion having an open center surrounded by a substantially flat circular surface whose boundary is defined by a predetermined radius;
a rim circumscribing the flat circular surface;
a surface of curvature extending from said boundary of the flat circular surface and curving downwardly along said rim to form a top surface and a bottom surface of the disc shaped member; and
a plurality of raised air flow spoiling members located on the top surface and said air flow spoiling members are generally semicircular and include a lengthwise and a width dimension wherein the lengthwise dimension is greater than the width dimension and the lengthwise dimension of the air flow spoiling members are aligned generally parallel to said boundary of the flat circular surface at a location generally spaced apart from the rim, said spoiling members comprising a plurality of intermittent raised and deformable ribs being concentric about said open center.

2. The toy according to claim 1 wherein said plurality of raised air flow spoiling members are evenly spaced.

3. The toy according to claim 1 wherein the rim has a greater thickness than the body portion of the disc shaped member and the entire disc shaped member is formed of a resilient and deformable material.

4. The toy according to claim 3 wherein said top surface of the disc shaped member includes a circumferential raised rib located generally adjacent to the open center.

5. The toy according to claim 1 wherein said top surface of the disc shaped member includes a raised and deformable circumferential rib located generally adjacent to the open center.

6. The toy according to claim 5 wherein said top surface of the disc shaped member includes a raised circumferential rib located generally adjacent to the intersection of the boundary and the rim.

7. The toy according to claim 1 wherein said bottom surface of the disc shaped member includes a circumferential raised and deformable rib located generally adjacent to and extending downwardly from the open center.

8. The toy according to claim 1 wherein said top surface of the disc shaped member includes a circumferential raised and deformable rib located generally adjacent to and extending upwardly from the open center and the bottom surface includes a circumferential raised rib located generally adjacent to and extending downwardly from the open center.

9. The toy according to claim 8 wherein the circumferential raised rib on the bottom surface includes a tapered surface that is generally tapered toward the open center.

10. An aerodynamic toy comprising:
A disc shaped member having a circular body portion having an open center surrounded by a substantially flat circular surface whose boundary is defined by a predetermined radius;
a rim circumscribing the flat circular surface;
a surface of curvature extending from said boundary of the flat circular surface and curving downwardly along said rim to form a top surface and a bottom surface of the disc shaped member;
a first raised air flow spoiling member located on the top surface and extending circumferentially around the flat circular surface adjacent to the rim, said air flow spoiling member comprising a continuous rib being concentric about said flat circular surface; and
a plurality of second air flow spoiling members located on the top surface of the disc shaped member and being circumferentially aligned about the top surface and spaced apart from the open center, said second air flow spoiling members having a generally semicircular shape with a lengthwise and a width dimension wherein the lengthwise dimension is greater than the width dimension and the lengthwise dimension of the air flow spoiling members are aligned concentrically with and parallel to said open center.

11. The toy according to claim 10 wherein a further raised and resilient air flow spoiling member is located on the top surface generally adjacent to the open center.

12. The toy according to claim 10 wherein the rim has a greater thickness than the body portion of the disc shaped member and the entire disc shaped member is formed of a resilient and deformable material.

13. The toy according to claim 10 wherein said rim of the disc shaped member includes an outer surface and an inner surface and the inner surface of the rim includes a generally flat surface and an upwardly and inwardly directed tapered surface.

14. The toy according to claim 10 wherein said bottom surface of the disc shaped member includes a plurality of raised circumferential ribs located generally spaced apart between the rim and the open center.

15. The toy according to claim 14 wherein said bottom surface of the disc shaped member includes a circumferential raised rib located generally adjacent to the open center and the circumferential raised rib is generally tapered to extend upwardly and outwardly from the open center.

16. An aerodynamic toy comprising:
A disc shaped member having a circular body portion having an open center surrounded by a substantially flat circular surface whose boundary is defined by a predetermined radius;
a rim circumscribing the flat circular surface;
a surface of curvature extending from said boundary of the flat circular surface and curving downwardly along said rim to form a top surface and a bottom surface of the disc shaped member;
a raised first air flow spoiling member located on the top surface and extending circumferentially around and adjacent to the open center, said spoiling member comprising a continuous and deformable rib being concentric about said open center;
a plurality of second air flow spoiling members located on the top surface and extending circumferentially spaced apart from the open center and said rim, said second air flow spoiling members having a semicircular shape with a lengthwise and a width dimension wherein the lengthwise dimension is greater than the width dimension and the lengthwise dimension of the air flow spoiling members are aligned concentrically with and parallel to said open center; and
wherein said rim of the disc shaped member includes an outer surface and an inner surface and the inner surface of the rim includes a generally flat surface and an upwardly directed tapered surface.

17. The toy according to claim 16 wherein said bottom surface of the disc shaped member includes a circumferential raised rib located generally adjacent to the open center and the circumferential raised rib is generally tapered upwardly toward the open center.

18. The toy according to claim 16 wherein the second air flow spoiling members consist of intermittent raised rib members which are aligned with the open center and the rim.

19. The toy according to claim 18 wherein said bottom surface of the disc shaped member includes a plurality of circumferential raised ribs located between the open center and the rim.

20. The toy according to claim 16 further including an additional raised rib adjacent to the outer boundary of the flat circular surface and the rim wherein the additional raised rib extends continuously along the entire circumference of the boundary of the flat circular surface.
